(19) United States
(12) Patent Application Publication
(10) Pub. No.: US 2025/0260760 A1
(43) Pub. Date: Aug. 14, 2025

(54) Cell Phone Holder and Related Methods

(71) Applicant: Dash Designs, Inc., Tempe, AZ (US)

(72) Inventors: Brad Schiff, Tempe, AZ (US); Dong Van Pham, Mesa, AZ (US); Kasey Cummings, Tempe, AZ (US)

(73) Assignee: Dash Designs, Inc., Tempe, AZ (US)

(21) Appl. No.: 19/048,892

(22) Filed: Feb. 8, 2025

Related U.S. Application Data
(60) Provisional application No. 63/551,767, filed on Feb. 9, 2024.

(51) Int. Cl. H04M 1/04

(52) U.S. Cl. CPC H04M 1/04

(57) ABSTRACT

Implementations of cell phone holders may include a base, a back coupled to the base, a front coupled to the back, and a foot directly coupled to the front and the base. The front may be foldable along a central fold. The foot may be fixed in an orientation parallel to the base. The cell phone holder may be configured to collapse to a flat configuration.

### CROSS REFERENCE TO RELATED APPLICATIONS

This document claims the benefit of the filing date of U.S. Provisional Patent Application 63/551,767, entitled “Cell Phone Holder” to Brad Schiff which was filed on Feb. 9, 2024, the disclosure of which is hereby incorporated entirely herein by reference.

### BACKGROUND

### 1. Technical Field

Aspects of this document relate generally to holders and supports, such as holders and supports for a cell phone.

### 2. Background

Supports and stands are used to hold objects and sometimes hold objects in an upright position. A support or stand could be used to hold a personal computing device. Supports and stands may be used to hold an object in a more upright position to facilitate a user's view of the object.

### SUMMARY

Implementations of cell phone holders may include a base, a back coupled to the base, a front coupled to the back, and a foot directly coupled to the front and the base. The front may be foldable along a central fold. The foot may be fixed in an orientation parallel to the base. The cell phone holder may be configured to collapse to a flat configuration.

Implementations of cell phone holders may include one, all, or any of the following:

A brace directly coupled to the back and configured to directly couple to the front when the cell phone holder is in an upright configuration.

The brace may include a brace tab configured to couple through a brace slot included in the front when the cell phone holder is in the upright configuration.

Implementations of the cell phone holder may include a front tab extending from the foot.

An inner surface of the foot may be fixedly and directly attached to the base.

Implementations of the cell phone holder may include a rear tab directly coupled to the base. An entire surface of the rear tab may be fixedly and directly attached to the brace.

Implementations of cell phone holders may include a base, a back coupled to the base, a front having a brace slot, the front coupled to the back, a brace directly coupled to back and to the front, the brace comprising a brace tab configured to be inserted within the brace slot, a foot directly coupled to the front and the base, and a front tab extending from the base and through a slit in the foot. The foot may be fixed in an orientation parallel to the base. The base, back, front, foot, and brace may be configured to lie substantially parallel to one another in a collapsed configuration. The cell phone holder may be configured to fold from an upright configuration to the collapsed configuration.

Implementations of cell phone holders may include one, all, or any of the following:

A first portion of the brace may be directly between the base and the front and a second portion of the brace may be directly between the base and back when the cell phone holder is in the collapsed configuration.

The base may include an opening corresponding in shape and size to the front tab.

The brace may include a second brace tab configured to couple within a second brace slot included in the front.

The brace slot may extend into the front from a first side of the front and the second brace slot may extend into the front from a second side of the front. The second side may be opposite the first side.

The front may include a central fold. The front may be configured to fold along the central fold when the cell phone holder is in the collapsed configuration. The front may be configured to be unfolded when the cell phone holder is in the upright configuration.

The foot may be configured to be fixedly attached to the base through an adhesive.

The slit in the foot may include a rounded opening at each end of the slit.

The central fold may be between the brace slot and the second brace slot.

Implementations of a method of forming a cell phone holder may include forming a first fold between a base tab and a base, forming a second fold between the base and a foot, forming a third fold between the foot and a front, forming a fourth fold between the front and a back, forming a fifth fold between the back and a brace, forming a sixth fold in a central portion of the front, fixedly adhering an entire surface of the rear tab to the brace, and folding a front tab away from the base and extending the front tab through a slit in the foot. The rear tab and brace may be coupled between the back, front, and base. The cell phone holder may be configured to fold between an upright configuration and a collapsed configuration. The front may be folded along the sixth fold in the collapsed configuration and may be unfolded along the sixth fold in the upright configuration.

Implementations of a method of forming a cell phone holder may include one, all, or any of the following:

The brace may be configured to fold flat against the base when the cell phone holder is in the collapsed configuration.

Methods of forming a cell phone holder may include fixedly adhering an inner surface of the foot to the base.

The front may include a first brace slot and a second brace slot configured to receive a first brace tab and a second brace tab included in the brace.

A longest length of the base may be equal to a longest length of the cell phone holder in the collapsed configuration.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a front perspective view of a cell phone holder;

FIG. 2 is a rear perspective view of the cell phone holder of FIG. 1;

FIG. 3 is a collapsed view of the cell phone holder of FIG. 1;

FIG. 4 is a bottom view of the cell phone holder of FIG. 1;

FIG. 5 is a side view of the cell phone holder of FIG. 1 in a partially collapsed configuration;

FIG. 6 is a view of an outer surface of a cell phone holder sheet;

FIG. 7 is a view of an inner surface of a cell phone holder sheet;

FIG. 8 is a front perspective view of the cell phone holder of FIG. 1 holding a cell phone; and

FIG. 9 is a front perspective view of a second implementation of a cell phone holder.

### DESCRIPTION

This disclosure, its aspects and implementations, are not limited to the specific components, assembly procedures or method elements disclosed herein. Many additional components, assembly procedures and/or method elements known in the art consistent with the intended cell phone holders will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such cell phone holders, and implementing components and methods, consistent with the intended operation and methods.

U.S. Provisional Pat. App. No. 63/551,767 (the '767 application), entitled “Cell Phone Holder” to Brad Schiff which was filed on Feb. 9, 2024, the disclosure of which is hereby incorporated entirely herein by reference, discloses various cell phone holders and related elements and methods that can be incorporated into the cell phone holders and related elements and methods disclosed herein.

While this application refers to the various implementations disclosed herein as “cell phone holders,” it is understood that the holders disclosed herein may be utilized to hold, or support, any other object having a shape related to the shape of a cell phone, such as, by non-limiting example, a tablet, a book, business cards, or a picture.

The implementations of the holders disclosed herein are foldable. In turn, the materials used to make the holders are, at least in part, foldable. The various implementations of the holders may be made from a paper product (such as cardboard or chipboard), plastic, or any other foldable material that also includes a sufficient rigidity to support a cell phone.

Any of the holders disclosed herein may be considered “disposable” inasmuch as they may cost very little to make, over time the materials of the holder may wear and lose functionality, and users may primarily use the holder for a single or temporary use (such as use over the period of a week). With this said, it is understood that the holders disclosed herein may also include a structure capable of multiple uses and may be intended for extended use.

Logos, advertisements, quick-response (QR) codes, and other information may be printed on the various surfaces of the cell phone holders. In turn, the holders disclosed herein may be utilized for marketing purposes. As an example, the holders disclosed herein may be distributed and utilized in restaurant or coffee shops where it is common for an individual to sit and look at their cell phone. The holders disclosed herein may provide a secure support for the cell phone rather than the user having to rearrange various objects on the table, such as glasses, condiments, plates, etc. to makeshift a support against which a cell phone may be leaned against.

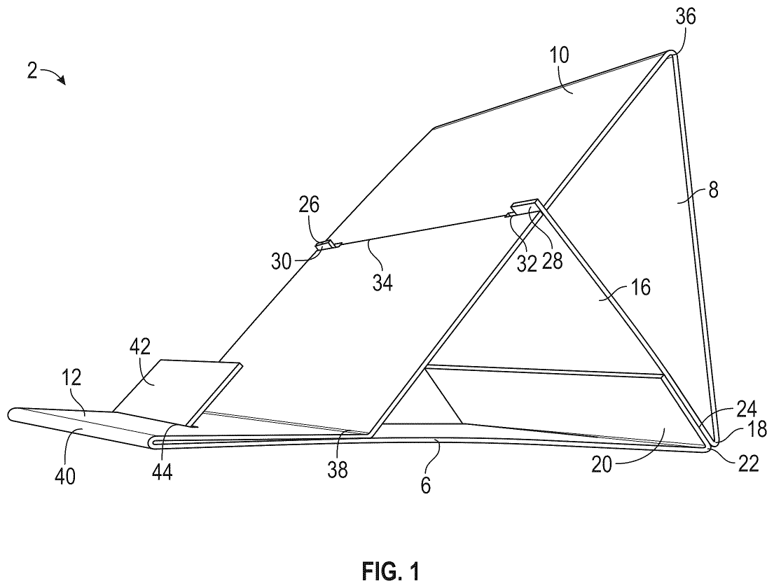

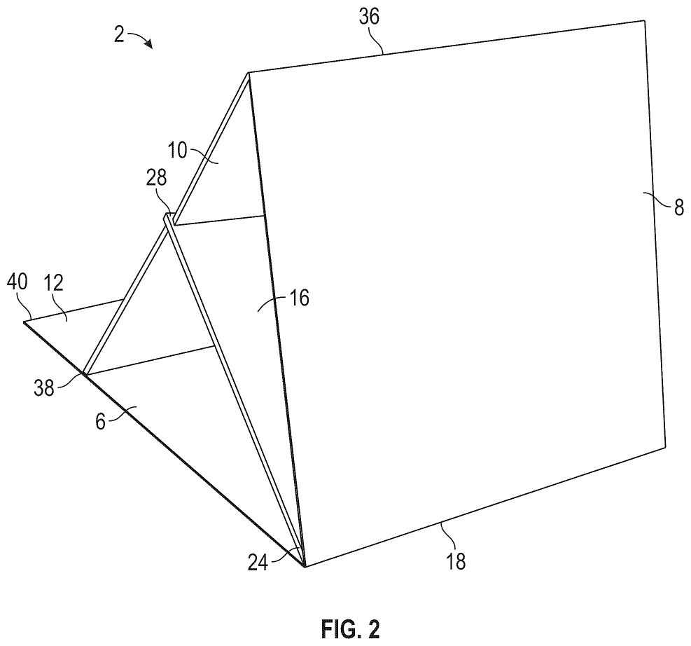

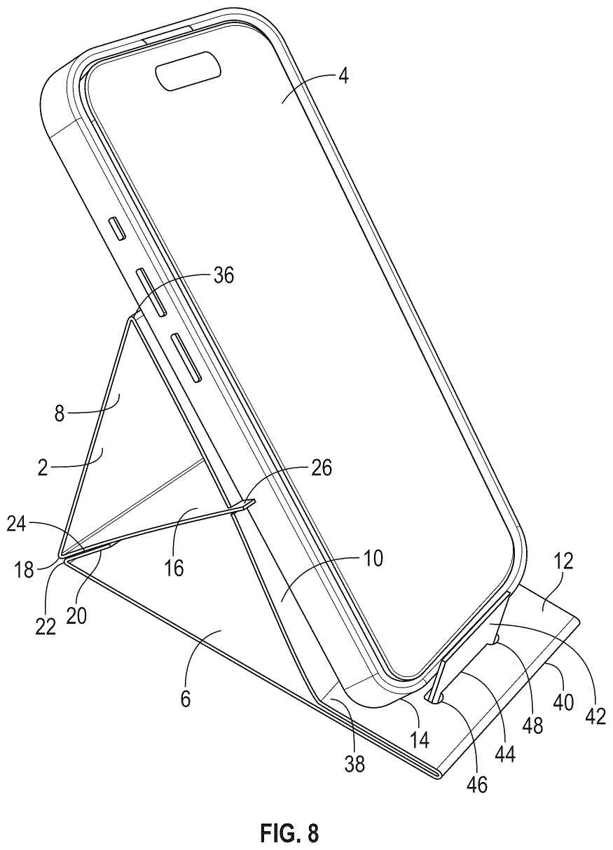

Referring to FIG. 1, a front perspective view of a cell phone holder is illustrated. Referring to FIG. 2, a rear perspective view of the cell phone holder of FIG. 1 is illustrated. Referring to FIG. 8, a front perspective view of the cell phone holder of FIG. 1 holding a cell phone is illustrated. The cell phone holder 2, or holder (“cell phone holder” and “holder” as used herein both refer to a cell phone holder), of FIGS. 1-2 and 8 illustrate the holder in an upright configuration. When in the upright configuration, the cell phone holder is configured to hold a cell phone 4 in an upright position. As used herein, terms of orientation, such as, by non-limiting example, front, back, rear, top, bottom, base, up, down, upper and lower are understood in relation to the orientation of the cell phone holder of FIG. 8 holding the cell phone when the cell phone holder is placed upon a flat surface. In turn, even if the cell phone holder is moved, collapsed, or rotated, terms of orientation are still understood to refer to portions of the cell phone holder as if it were oriented according to the orientation of FIG. 8.

The holder of FIGS. 1-2 and 8 includes a base 6, back 8, front 10, and foot 12. As used herein, the base 6 of the holder 2 is the portion of the holder configured to contact a table, or other surface, when the holder is folded (or in an upright configuration) and in use. The front 10 of the holder 2 is the portion configured to contact and directly support the cell phone 4 when the holder is folded and in use. The back 8 of the holder 2 is the portion opposite the front 10 and is coupled between the base 6 and the front when the holder is folded and in the upright configuration. The foot 12 of the holder extends from the front and is configured to contact a bottom 14 of the phone 4.

In various implementations, a width of the holder 2, which may equal a width of each of the front 10, back 8, base 6, and foot 12, may be 74 mm. In other implementations, the width of the holder 2 may be more than or less than 74 mm.

Still referring to FIGS. 1-2 and 8, in various implementations the holder 2 includes a brace 16. The brace 16 may include a width equal to that of the holder 2. In other implementations, the brace 16 may include a width less than that of the holder 2. Particular implementations of the brace 16 may include a length of 63 mm. Other implementations of holders may include a brace longer or shorter than 63 mm.

The brace 16 may be directly coupled to the back 8. In such implementations, the holder 2 may include a fold 18 between the brace 16 and the back 8 through which the brace may bend relative to the back.

In various implementations, the holder 2 includes a rear tab 20, or back foot. The rear tab 20 may be directly coupled to the base 6. In various implementations, the holder 2 may include a fold 22 between the rear tab 20 and the base 6 through which the rear tab may bend relative to the base.

In various implementations, the rear tab 20 may be fixedly coupled to the brace 16. In such implementations, the rear tab 20 may be fixed to the brace 16 through a fixing mechanism such as, by non-limiting example, glue, double sided tape, a staple, or other adhesive or mechanical fixing mechanism.

In other implementations, the position of the brace and the rear tab may be switched such that the rear tab is directly coupled to the bottom of the back and the brace is directly coupled to the base. In either implementation, the brace 16 is configured to extend from a bottom corner 24 of the holder 2 to the front 10 when the holder 2 is in the upright configuration.

In other implementations, the holder may not include a brace tab. In such implementations, a portion of the brace, if directly coupled to the back, may be fixedly coupled to the base and the remainder of the brace may be configured to extend towards the front when the holder is in an upright configuration. Similarly, in implementations where the brace is directly coupled to the base, a portion of the brace may be fixedly coupled to the back and the remainder of the brace may be configured to extend towards the front when the holder is in an upright configuration. In such implementations, the brace may include a fold between the portion of the brace fixedly coupled to the base or back and the remainder of the brace.

Referring to FIG. 1, in various implementations, the brace 16 includes a first brace tab 26 and a second brace tab 28. The brace tabs are configured to engage within, or be inserted within, a first brace slot 30 and a second brace slot 32. While FIG. 1 illustrates two brace tabs and two corresponding brace slots, in other implementations the brace may include only a single brace tab, three brace tabs, or more than three brace tabs. Likewise, in these other implementations the front may include a corresponding single brace slot, three brace slots, or more than three brace slots.

In various implementations, and as illustrated by FIG. 1, the brace tabs may be on the outer sides of the brace and the brace slots may cut into the front from opposing sides of the front 10. In other implementations, the brace tabs (or tab) may be located at other positions along the edge of the brace and the slots may be located at corresponding locations along a width of the front.

In various implementations, the brace tabs may be configured to fold flat against the front after being inserted through the brace slots. In other implementations, the brace tabs may not be folded flat against the front.

Particular implementations of the brace tabs may be 6 mm wide and 3 mm long. In other implementations, the width may be more than or less than 6 mm and the length may be more than or less than 3 mm.

In other implementations, the holder may not include a brace illustrated by FIG. 1. In such implementations, the holder may include other structural features that enable it to hold a phone without collapsing (including any features disclosed in the '767 application).

The front 10 of the holder 2 may be directly coupled to the back 8. In various implementations, the holder 2 may include a fold 36 between the front 10 and the back 8 through which the front 10 may bend relative to the back 8.

The front 10 of the holder 2 may be directly coupled to the foot 12. In various implementations, the holder 2 may include a fold 38 between the front 10 and the foot 12 through which the front 10 may bend relative to the foot 12.

In various implementations, the front 10 includes a central fold 34 extending along a midsection of the front. In such implementations, the holder may be folded along the central fold line to flatten/collapse the holder. Once flattened, an upper portion of the front 10 may face and be parallel to a lower portion of the front. This may facilitate transportation of the holder after it has been used (i.e. a user may leave a coffee shop, collapse the holder, and put it in their pocket to be used at a different time). The holder 2 may then pop-up or be unfolded by undoing the fold at the central fold 34.

In various implementations, the central fold 34 line may extend across a width of the front 10 between the first brace slot 30 and the second brace slot 32. In other implementations, the central fold line may not be aligned with the brace slots.

The holder 2 includes a foot 12 directly coupled to a bottom edge of the front 10. The foot 12, as illustrated by FIG. 8, is configured to hold a phone 4 and contact a bottom edge 14 of the phone when the phone is leaning against the front 10 of the holder. The foot may be fixed in an orientation parallel to the base.

The foot 12 may include or have a phone retention mechanism coupled thereto. The phone retention mechanism prevents the phone from sliding off the foot and falling from the holder. In various implementations, the retention mechanism may include a material having a high enough coefficient of friction that the phone does not slide off the foot. Such a material could include silicon or rubber. This material may cover an entire upper surface of the foot or could cover only a portion of the upper surface of the foot (such as a strip of material or spaced patches of material). In other implementations, and as illustrated by FIGS. 1 and 8, the retention mechanism may include a front tab 42 configured to block the phone 4 to prevent it from falling from the holder 2.

In various implementations, the holder includes a fold 40 between the foot 12 and the base 6. In various implementations, the foot 12 may be configured to bend relative to the base 6 through the fold 40. In other implementations, the surface of the foot 12 facing the base may be fixedly attached to the base 6. In such implementations, the surface of the foot facing the base may be fixed to the base through any fixing mechanism disclosed herein (such as an adhesive).

In various implementations where the foot 12 has a front tab extending therefrom, the foot may include a slit 44. In particular implementations, the slit 44 may include a first circular (or other shaped) opening 46 on a first end of the slit and a second circular (or other shaped) opening 48 on the opposing second end of the slit. The circular openings may facilitate reception of the front tab by the slit.

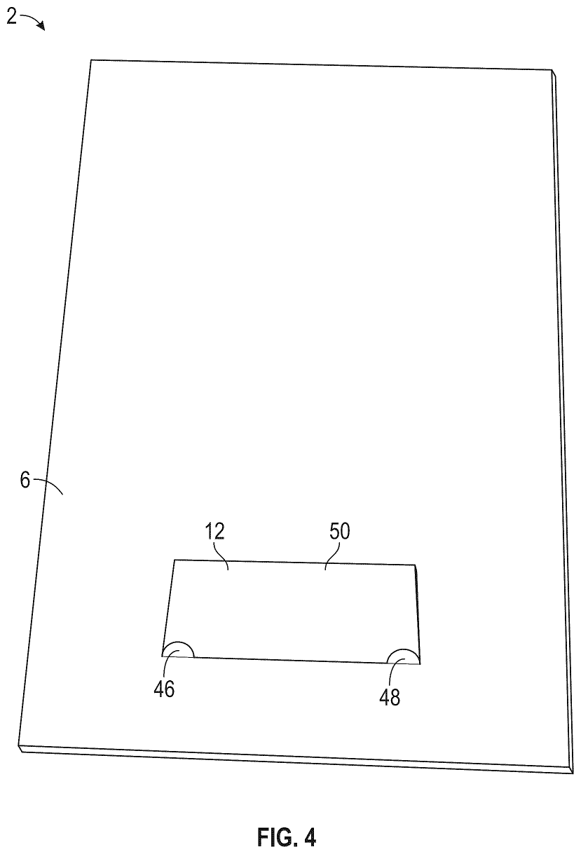

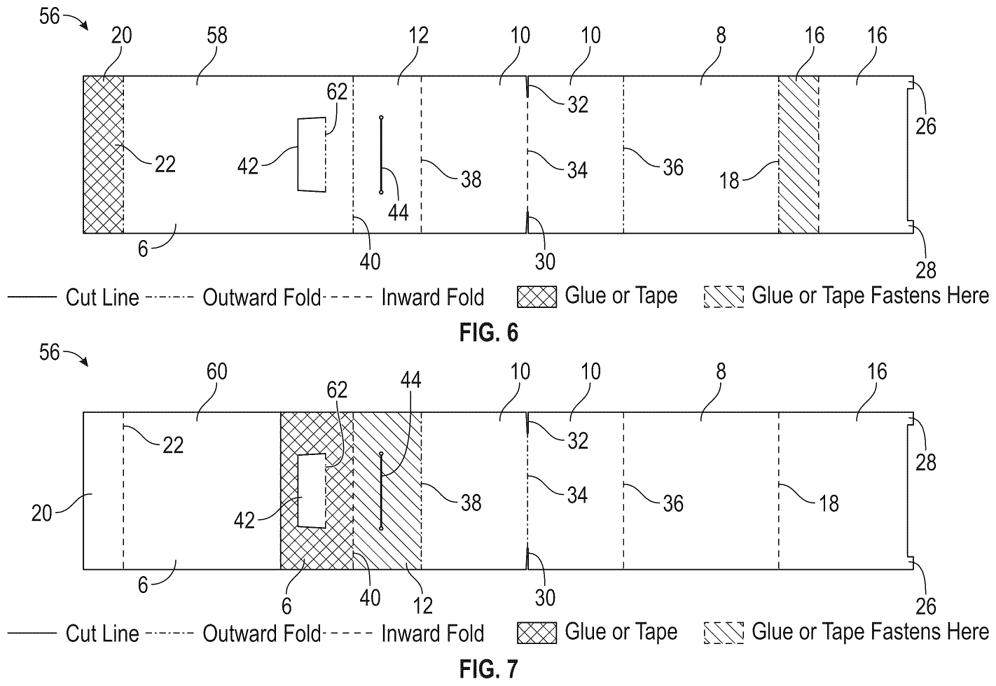

As illustrated by FIGS. 1 and 8, the holder 2 may include a front tab 42. The front tab 42 extends from the foot and is configured to brace against a base of a phone to prevent the phone from sliding. In particular implementations, the foot 12 may fold from the base 6 and extend through the slit 44 in the foot 12. Referring to FIG. 4, a bottom view of the cell phone holder of FIG. 1 is illustrated. As illustrated, the base 6 includes an opening 50 therein through which the bottom of the foot 12 is exposed. The opening 50 may correspond in shape and size to the front tab. As depicted by FIGS. 6-7, the front tab may be hingedly coupled to the base and may extend from the base, through the slit, and from the foot. In other implementations, the front tab may be separately attached to the foot through an adhesive.

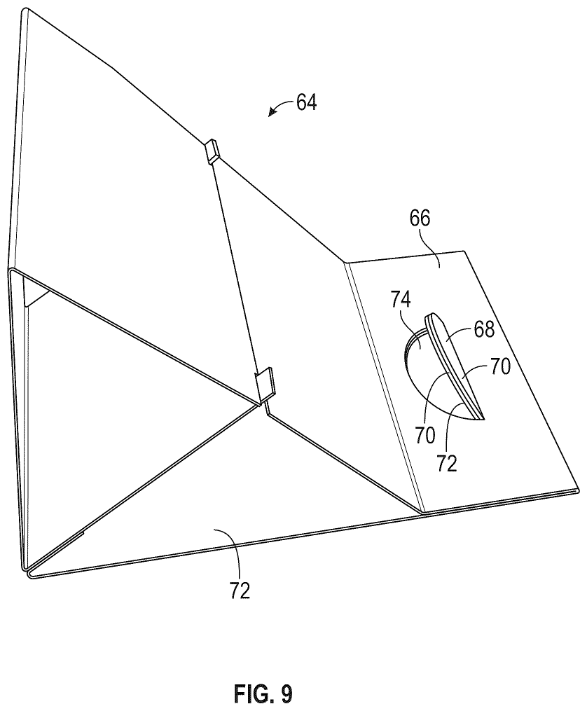

Referring to FIG. 9, a second implementation of a holder 64 is illustrated. The holder 64 is similar to the holder 2 of FIGS. 1-2 with the key difference being that rather than the front tab folding from the base of the holder and through a slit in the foot, the front tab 70 may include a first layer that is folded up from the foot 66 and a second layer 72 that is folded up from the base. In such implementations, the foot 66 may include an opening 74 that extends entirely through the foot and the base. The front tab may be more rigid due to the dual layers.

The front tab may include a variety of shapes including, but not limited to, a semicircle (as illustrated by FIG. 9), a rectangle (as illustrated by FIG. 1), or any other shape.

Referring back to the holder 2 of FIG. 1, in various implementations the base 6 may include a longest length that is equal to a longest length of the holder.

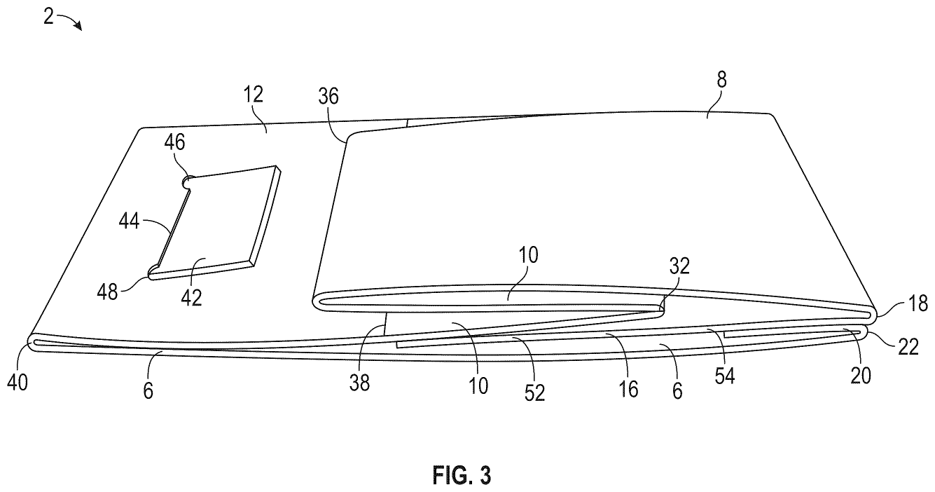

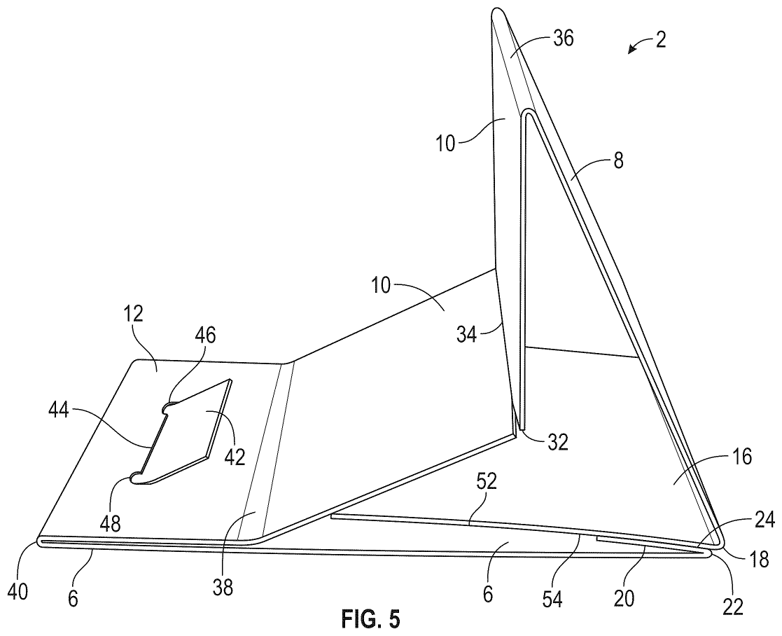

The implementations of the holders disclosed herein are collapsible. Referring to FIG. 3, a collapsed view of the cell phone holder of FIG. 1 is illustrated. As illustrated by FIG. 1, when the brace 16 is disengaged from the front 10, the front may fold along the central fold line and the front, back 8, and brace may collapse and lay substantially parallel to the base 6. The front tab 42 may also collapse and lay substantially parallel to the base 6. When fully collapsed, the brace 16 may include a first portion 52 directly between the front 10 and the base 6 and a second portion 54 directly between the back 18 and the base 6. In other implementations, the front 10 may collapse below the brace and the first portion 52 of the brace 16 may be directly between the front 10 and the back 8 and the second portion 54 may be directly between the base 6 and the back 8. While FIG. 3 illustrates a fully collapsed view of the holder, referring to FIG. 5, a side view of the cell phone holder of FIG. 1 in a partially collapsed configuration is illustrated. The collapsible functionality of the holders disclosed herein may facilitate transportation, shipping, and storage of the holders. Because it can be easily collapsed and returned to the upright configuration, the holder 2 is convenient for repeated use and is easily carried in the pocket of user as it can lay flat.

Referring to FIG. 6, a view of an outer surface of a cell phone holder sheet is illustrated. Referring to FIG. 7, a view of an inner surface of a cell phone holder sheet is illustrated. The cell phone holder sheet 56 (hereinafter referred to as “sheet”), may be used to form the holder 2 of FIG. 1. FIG. 6 illustrates the outer surface 58 of the holder 2 when the holder is in an upright configuration while FIG. 7 illustrates the inner surface 60 of the holder 2 when the holder is in an upright configuration. Like reference numerals are used between the sheet 56 and the holder 2 to show the portions of the sheet that form the respective portions of the holder. As illustrated by FIGS. 6-7, the sheet includes a first fold 22 between a rear tab 20 and a base 6, a second fold 40 between the base 6 and the foot 12, a third fold 38 between the foot 12 and the front 10, a fourth fold 36 between the front 10 and the back 8, a fifth fold 18 between the back 8 and a brace 16, and a sixth fold, or central fold 34 in a central portion of the front 10. FIGS. 6-7 indicate which of these folds are outward (convex, the dot-dash lines) or inward (concave, the dash-dash lines). FIGS. 6-7 also illustrate the portions of the outer surface and the inner surface that are adhered to one another through glue, tape, or some other adhesive or fixing mechanism.

As illustrated by FIGS. 6-7, a single sheet may form the entire holder. In other implementations, the holder may be made from multiple sheets coupled together.

In various implementations, the outer surface of the sheet may have content printed thereon, such as a logo, advertisement, picture, QR code, or other material. This content may enable the holder 2 to serve as marketing material. In various implementations, the inner surface of the sheet may also have content printed thereon.

Referring back to FIG. 1, the brace 16 is directly coupled to the back 8 through the fold 18 and extends to the brace the front having the central fold line. In other implementations, the front may not include a central fold line but either the base 6 or the back 8 may include the central fold line. In such implementations, the brace may be directly coupled to the front and extend to the base or directly coupled to the base and extend to the back. In such implementations, the rear tab fixed to the brace may be directly coupled to the front 10 or the back 8.

The method of forming a cell phone holder may include forming or providing a sheet. The sheet may be the same as or similar to any sheet disclosed herein. The method may include printing content, such as marketing material, onto the sheet. In various implementations, the method may include cutting brace slots and/or a slit through the foot. The method may further include coupling a retention mechanism separate from the sheet to the foot. In other implementations, the method may include cutting a front tab in a base of a sheet to be used as the retention mechanism.

In various implementations, the method may include applying an adhesive (such as a glue or double sided tape) to either of the rear tab or the brace and to either of the base or the foot.

The method may include forming a first fold between a rear tab and a base, forming a second fold between the base and a foot, forming a third fold between the foot and a front, forming a fourth fold between the front and a back, forming a fifth fold between the back and a brace, and forming a sixth fold in a central portion of the front.

In various implementations, the method may include fixedly adhering the surface of the rear tab to the brace. The method may also include fixedly adhering an inner surface of the foot to the base.

In implementations including a front tab, the method may include folding a front tab away from the base and extending the front tab through a slit in the foot. A user may then adjust the configuration of the cell phone holder between a collapsed configuration and an upright configuration configured to hold a phone in an upright position.

In places where the description above refers to particular implementations of cell phone holders and implementing components, sub-components, methods and sub-methods, it should be readily apparent that a number of modifications may be made without departing from the spirit thereof and that these implementations, implementing components, sub-components, methods and sub-methods may be applied to other cell phone holders.

What is claimed is:

1. A cell phone holder comprising:
a base;
a back coupled to the base;
a front coupled to the back, wherein the front is foldable along a central fold; and
a foot directly coupled to the front and the base, wherein the foot is fixed in an orientation parallel to the base;
wherein the cell phone holder is configured to collapse to a flat configuration.

2. The cell phone holder of claim 1, further comprising a brace directly coupled to the back and configured to directly couple to the front when the cell phone holder is in an upright configuration.

3. The cell phone holder of claim 2, wherein the brace comprises a brace tab configured to couple through a brace slot comprised in the front when the cell phone holder is in the upright configuration.

4. The cell phone holder of claim 1, further comprising a front tab extending from the foot.

5. The cell phone holder of claim 1, wherein an inner surface of the foot is fixedly and directly attached to the base.

6. The cell phone holder of claim 1, further comprising a rear tab directly coupled to the base, wherein an entire surface of the rear tab is fixedly and directly attached to a brace.

7. A cell phone holder comprising:
a base;
a back coupled to the base;
a front coupled to the back, the front comprising a brace slot;
a brace directly coupled to back and to the front, the brace comprising a brace tab configured to be inserted within the brace slot;
a foot directly coupled to the front and the base, wherein the foot is fixed in an orientation parallel to the base; and
a front tab extending from the base and through a slit in the foot;
wherein the base, back, front, foot, and brace are configured to lie substantially parallel to one another in a collapsed configuration; and
wherein the cell phone holder is configured to fold from an upright configuration to the collapsed configuration.

8. The cell phone holder of claim 7, wherein a first portion of the brace is directly between the base and the front and a second portion of the brace is directly between the base and back when the cell phone holder is in the collapsed configuration.

9. The cell phone holder of claim 7, wherein the base comprises an opening corresponding in shape and size to the front tab.

10. The cell phone holder of claim 7, wherein the brace further comprises a second brace tab configured to couple within a second brace slot comprised in the front.

11. The cell phone holder of claim 10, wherein the brace slot extends into the front from a first side of the front and the second brace slot extends into the front from a second side of the front, the second side opposite the first side.

12. The cell phone holder of claim 7, wherein the front comprises a central fold, wherein the front is configured to fold along the central fold when the cell phone holder is in the collapsed configuration, and wherein the front is configured to be unfolded when the cell phone holder is in the upright configuration.

13. The cell phone holder of claim 7, wherein the foot is configured to be fixedly attached to the base through an adhesive.

14. The cell phone holder of claim 7, wherein the slit in the foot comprises a rounded opening at each end of the slit.

15. The cell phone holder of claim 12, wherein the central fold is between the brace slot and a second brace slot.

16. A method of forming a cell phone holder, the method comprising:
forming a first fold between a rear tab and a base;
forming a second fold between the base and a foot;
forming a third fold between the foot and a front;
forming a fourth fold between the front and a back;
forming a fifth fold between the back and a brace;
forming a sixth fold in a central portion of the front;
fixedly adhering an entire surface of the rear tab to the brace, wherein the rear tab and brace are coupled between the back, front, and base; and
folding a front tab away from the base and extending the front tab through a slit in the foot;
wherein the cell phone holder is configured to fold between an upright configuration and a collapsed configuration; and
wherein the front is folded along the sixth fold in the collapsed configuration and is unfolded along the sixth fold in the upright configuration.

17. The method of claim 16, wherein the brace is configured to fold flat against the base when the cell phone holder is in the collapsed configuration.

18. The method of claim 16, further comprising fixedly adhering an inner surface of the foot to the base.

19. The method of claim 16, wherein the front comprises a first brace slot and a second brace slot configured to receive a first brace tab and a second brace tab comprised in the brace.

20. The method of claim 16, wherein a longest length of the base is equal to a longest length of the cell phone holder in the collapsed configuration.
